(19) United States
(12) Patent Application Publication
(10) Pub. No.: US 2023/0041083 A1
(43) Pub. Date: Feb. 9, 2023

(54) POLYMER FILM AND METHOD OF PRODUCING SAME, AND LAMINATE AND METHOD OF PRODUCING SAME

(71) Applicant: FUJIFILM Corporation, Tokyo (JP)

(72) Inventors: Hirotaka KITAGAWA, Shizuoka (JP); Daisuke HAYASHI, Shizuoka (JP)

(73) Assignee: FUJIFILM Corporation, Tokyo (JP)

(21) Appl. No.: 17/861,261

(22) Filed: Jul. 11, 2022

(30) Foreign Application Priority Data
Jul. 30, 2021 (JP) 2021-126191

(51) Int. Cl. C09K 19/38; C08J 5/18

(52) U.S. Cl. CPC C09K 19/3809; C08J 5/18; C08J 2367/04

(57) ABSTRACT

Provided are a polymer film including a particle-containing layer that contains at least one resin selected from the group consisting of a liquid crystal polymer, a polysulfone resin, a polyethersulfone resin, and a polyphenylene sulfide resin, and liquid crystal polymer particles, in which a content of the liquid crystal polymer particles in the particle-containing layer is 40% by volume or greater, and a method of producing the same, and a laminate formed of the polymer film and a method of producing the same.

### CROSS-REFERENCE TO RELATED APPLICATION

This application is based on and claims priority under 35 USC 119 from Japanese Patent Application No. 2021-126191, filed Jul. 30, 2021, the disclosure of which is incorporated by reference herein.

### BACKGROUND OF THE INVENTION

### 1. Field of the Invention

The present disclosure relates to a polymer film and a method of producing the same, and a laminate and a method of producing the same.

### 2. Description of the Related Art

In recent years, the frequencies used in communication equipment tend to be extremely high. In order to suppress transmission loss in a high frequency band, insulating materials used in circuit boards are required to decrease the relative dielectric constant and the dielectric loss tangent.

As liquid crystal polymer articles of the related art, for example, a liquid crystal polymer article described in JP1995-3124A (JP-H07-3124A) has been known.

JP1995-3124A (JP-H07-3124A) discloses a multiaxially reinforced liquid crystal polymer article containing a polymer matrix and aligned particles embedded in the matrix, in which the aligned particles contain a first liquid crystal polymer, and the matrix contains a second liquid crystal polymer having a melting point lower than that of the first liquid crystal polymer.

### SUMMARY OF THE INVENTION

An object to be achieved by an aspect of the present invention is to provide a polymer film having a small dielectric loss tangent and a method of producing the same.

Further, an object to be achieved by another aspect of the present invention is to provide a laminate formed of the polymer film and a method of producing the same.

The means for achieving the above-described object includes the following aspects.
<1> A polymer film comprising: a particle-containing layer that contains at least one resin selected from the group consisting of a liquid crystal polymer, a polysulfone resin, a polyethersulfone resin, and a polyphenylene sulfide resin, and liquid crystal polymer particles, in which a content of the liquid crystal polymer particles in the particle-containing layer is 40% by volume or greater.
<2> The polymer film according to <1>, in which the resin is a liquid crystal polymer.
<3> The polymer film according to <1> or <2>, in which a solubility of the resin in N-methylpyrrolidone at 140° C. is 1% by mass or greater.
<4> The polymer film according to any one of <1> to <3>, in which the resin contains a liquid crystal polymer having a constitutional repeating unit represented by any of Formulae (1) to (3),

—O—Ar¹—CO— Formula (1)

—CO—Ar²—CO— Formula (2)

—X—Ar³—Y— Formula (3)

in Formulae (1) to (3), Ar¹ represents a phenylene group, a naphthylene group, or a biphenylylene group, Ar² and Ar³ each independently represent a phenylene group, a naphthylene group, a biphenylylene group, or a group represented by Formula (4), X and Y each independently represent an oxygen atom or an imino group, and hydrogen atoms in the groups represented by Ar¹ to Ar³ may be each independently substituted with a halogen atom, an alkyl group, or an aryl group,

—Ar⁴—Z—Ar⁵— Formula (4)

in Formula (4), Ar⁴ and Ar⁵ each independently represent a phenylene group or a naphthylene group, and Z represents an oxygen atom, a sulfur atom, a carbonyl group, a sulfonyl group, or an alkylene group.
<5> The polymer film according to any one of <1> to <4>, in which the liquid crystal polymer particles have a dielectric loss tangent less than a dielectric loss tangent of the resin.
<6> The polymer film according to any one of <1> to <5>, in which the liquid crystal polymer particles have a median diameter of 0.1 μm to 30 μm.
<7> The polymer film according to any one of <1> to <6>, in which the liquid crystal polymer particles include liquid crystal polymer particles, each surface of which is subjected to an oxidation treatment.
<8> A laminate comprising: the polymer film according to any one of <1> to <7>; and a metal layer or metal wire.
<9> The laminate according to <8>, further comprising: a resin layer between the polymer film and the metal layer or the metal wire.
<10> The laminate according to <9>, in which the resin layer contains the resin in the particle-containing layer.
<11> The laminate according to <9> or <10>, in which an average thickness of the resin layer is 5 μm or less.
<12> A method of producing a polymer film, comprising: a forming step of coating a base material with a polymer solution that contains at least one resin selected from the group consisting of a liquid crystal polymer, a polysulfone resin, a polyethersulfone resin, and a polyphenylene sulfide resin, liquid crystal polymer particles, and an organic solvent and drying the solution to form a particle-containing layer on the base material; and a heating step of heating the particle-containing layer at a temperature higher than or equal to a glass transition temperature of the resin, in which a content of the liquid crystal polymer particles in the particle-containing layer after the heating step is 40% by volume or greater.
<13> A method of producing a laminate, comprising: a laminate forming step of coating a base material with a polymer solution that contains at least one resin selected from the group consisting of a liquid crystal polymer, a polysulfone resin, a polyethersulfone resin, and a polyphenylene sulfide resin, liquid crystal polymer particles, and an organic solvent and drying the solution to form a laminate including a particle-containing layer on the base material; and a heating step of heating the particle-containing layer at a temperature higher than or equal to a glass transition temperature of the resin, in which a content of the liquid crystal polymer particles in the particle-containing layer after the heating step is 40% by volume or greater.
<14> The method of producing a laminate according to <13>, in which the base material includes a metal layer or metal wire.
<15> The method of producing a laminate according to <14>, in which a surface roughness Rz of a surface of the metal layer or the metal wire on a side of the particle-containing layer is 1.0 μm or less.
<16> The method of producing a laminate according to any one of <13> to <15>, in which the laminate further includes a resin layer between the base material and the particle-containing layer.
<17> The method of producing a laminate according to any one of <13> to <16>, in which the resin layer contains the resin in the particle-containing layer.

According to the aspect of the present invention, it is possible to provide a polymer film having a small dielectric loss tangent and a method of producing the same.

Further, according to another aspect of the present invention, it is possible to provide a laminate formed of the polymer film and a method of producing the same.

### DESCRIPTION OF THE PREFERRED EMBODIMENTS

Hereinafter, the contents of the present disclosure will be described in detail. The description of configuration requirements below is made based on representative embodiments of the present disclosure in some cases, but the present disclosure is not limited to such embodiments.

Further, in the present specification, a numerical range shown using “to” indicates a range including numerical values described before and after “to” as a lower limit and an upper limit.

In a numerical range described in a stepwise manner in the present disclosure, an upper limit or a lower limit described in one numerical range may be replaced with an upper limit or a lower limit in another numerical range described in a stepwise manner. Further, in a numerical range described in the present disclosure, an upper limit or a lower limit described in the numerical range may be replaced with a value described in an example.

Further, in a case where substitution or unsubstitution is not noted in regard to the notation of a “group” (atomic group) in the present specification, the “group” includes not only a group that does not have a substituent but also a group having a substituent. For example, the concept of an “alkyl group” includes not only an alkyl group that does not have a substituent (unsubstituted alkyl group) but also an alkyl group having a substituent (substituted alkyl group).

In the present specification, the concept of “(meth)acryl” includes both acryl and methacryl, and the concept of “(meth)acryloyl” includes both acryloyl and methacryloyl.

Further, the term “step” in the present specification indicates not only an independent step but also a step which cannot be clearly distinguished from other steps as long as the intended purpose of the step is achieved.

Further, in the present disclosure, “% by mass” has the same definition as that for “% by weight”, and “part by mass” has the same definition as that for “part by weight”.

Further, in the present disclosure, a combination of two or more preferred embodiments is a more preferred embodiment.

Further, the weight-average molecular weight (Mw) and the number average molecular weight (Mn) in the present disclosure are molecular weights converted using polystyrene as a standard substance by performing detection with a gel permeation chromatography (GPC) analyzer using TSKgel SuperHM-H (trade name, manufactured by Tosoh Corporation) column, a solvent of pentafluorophenol (PFP) and chloroform at a mass ratio of 1:2, and a differential refractometer, unless otherwise specified.

Polymer Film

A polymer film according to the present disclosure is a polymer film including a particle-containing layer that contains at least one resin selected from the group consisting of a liquid crystal polymer, a polysulfone resin, a polyethersulfone resin, and a polyphenylene sulfide resin, and liquid crystal polymer particles, in which the content of the liquid crystal polymer particles in the particle-containing layer is 40% by volume or greater.

As a result of intensive research conducted by the present inventors, it was found that a polymer film having a small dielectric loss tangent can be provided by employing the above-described configuration.

The detailed mechanism by which the above-described effect is obtained is not clear, but can be assumed as follows.

Since the polymer film according to the present disclosure contains at least one resin selected from the group consisting of a liquid crystal polymer, a polysulfone resin, a polyethersulfone resin, and a polyphenylene sulfide resin, and liquid crystal polymer particles, the particle-containing layer can be highly filled with the liquid crystal polymer particles, and thus a polymer film having a small dielectric loss tangent can be provided by the liquid crystal polymer particles highly filling the particle-containing layer.

Particle-Containing Layer

The polymer film according to the present disclosure includes a particle-containing layer, and the particle-containing layer contains at least one resin selected from the group consisting of a liquid crystal polymer, a polysulfone resin, a polyethersulfone resin, and a polyphenylene sulfide resin, and liquid crystal polymer particles.

Further, the content of the liquid crystal polymer particles in the particle-containing layer is 40% by volume or greater.

Resin

The particle-containing layer contains at least one resin selected from the group consisting of a liquid crystal polymer, a polysulfone resin, a polyethersulfone resin, and a polyphenylene sulfide resin, and liquid crystal polymer particles. Among these, a liquid crystal polymer is preferable from the viewpoint of the dielectric loss tangent of the film, and at least one resin selected from the group consisting of a polysulfone resin, a polyethersulfone resin, and a polyphenylene sulfide resin is preferable from the viewpoints of heat resistance and mechanical strength.

The weight-average molecular weight Mw of the resin is preferably 1,000 or greater, more preferably 2,000 or greater, and particularly preferably 5,000 or greater. The weight-average molecular weight Mw of the resin is preferably 1,000,000 or less, more preferably 300,000 or less, and particularly preferably less than 100,000.

From the viewpoints of the dielectric loss tangent of the film, the adhesiveness of the film to metal foil or metal wire, and the heat resistance, the glass transition temperature Tg of the resin is preferably 150° C. or higher, more preferably 200° C. or higher, and particularly preferably 200° C. or higher and lower than 280° C.

The glass transition temperature Tg in the present disclosure is defined as a value measured by a differential scanning calorimetry (DSC) device.

From the viewpoints of the dielectric loss tangent and rupture elongation of the film, the solubility of the resin in N-methylpyrrolidone at 140° C. is preferably 1% by mass or greater, more preferably 2% by mass or greater, still more preferably 3% by mass or greater, and particularly preferably 5% by mass or greater.

Polysulfone Resin, Polyethersulfone Resin, and Polyphenylene Sulfide Resin

The polysulfone resin is a resin having a constitutional repeating unit containing a sulfonyl group (—S(═O)₂—), and examples thereof include a resin obtained by desalting polycondensation of 4,4′-dichlorodiphenylsulfone (DCDPS) and a sodium salt of bisphenol A.

The polysulfone resin is not particularly limited, and known resins can be used.

The polyethersulfone resin is a resin having a constitutional repeating unit containing a sulfonyl group (—S(═O)₂—) and an ether bond (—O—), and examples thereof include a resin obtained by desalting polycondensation of 4,4′-dichlorodiphenylsulfone (DCDPS) and bisphenol S (Bis-S).

The polyethersulfone resin is not particularly limited, and known resins can be used.

The polyphenylene sulfide resin is a resin in which benzene rings and sulfur atoms are alternately bonded.

The polyphenylene sulfide resin is not particularly limited, and known resins can be used.

Liquid Crystal Polymer

From the viewpoint of the dielectric loss tangent of the film, it is preferable that the resin is a liquid crystal polymer.

In the present disclosure, it is preferable that the liquid crystal polymer has a dielectric loss tangent of 0.01 or less. Further, the kind of the liquid crystal polymer is not particularly limited, and a known liquid crystal polymer can be used.

Further, the liquid crystal polymer may be a thermotropic liquid crystal polymer that exhibits liquid crystallinity in a melting state or may be a lyotropic liquid crystal polymer that exhibits liquid crystallinity in a solution state. Further, in a case of the thermotropic liquid crystal polymer, it is preferable that the polymer is melted at a temperature of 450° C. or lower.

Examples of the liquid crystal polymer include liquid crystal polyester, liquid crystal polyester amide in which an amide bond is introduced into liquid crystal polyester, liquid crystal polyester ether in which an ether bond introduced into liquid crystal polyester, and liquid crystal polyester carbonate in which a carbonate bond is introduced into liquid crystal polyester.

Further, from the viewpoint of the liquid crystallinity and the linear expansion coefficient, a polymer having an aromatic ring is preferable, and aromatic polyester or aromatic polyester amide is more preferable as the liquid crystal polymer.

Further, the liquid crystal polymer may be a polymer in which an imide bond, a carbodiimide bond, a bond derived from an isocyanate such as an isocyanurate bond, or the like is further introduced into aromatic polyester or aromatic polyester amide.

Further, it is preferable that the liquid crystal polymer is a wholly aromatic liquid crystal polymer formed of only an aromatic compound as a raw material monomer.

Examples of the liquid crystal polymer include
1) a liquid crystal polymer obtained by polycondensing an aromatic hydroxycarboxylic acid (i), an aromatic dicarboxylic acid (ii), and at least one compound (iii) selected from the group consisting of an aromatic diol, an aromatic hydroxyamine and an aromatic diamine,
2) a liquid crystal polymer obtained by polycondensing a plurality of kinds of aromatic hydroxycarboxylic acids,
3) a liquid crystal polymer obtained by polycondensing an aromatic dicarboxylic acid (i) and at least one compound (ii) selected from the group consisting of an aromatic diol, an aromatic hydroxyamine, and an aromatic diamine, and
4) a liquid crystal polymer obtained by polycondensing polyester (i) such as polyethylene terephthalate and an aromatic hydroxycarboxylic acid (ii).

Here, as a part or the entirety of the aromatic hydroxycarboxylic acid, the aromatic dicarboxylic acid, the aromatic diol, the aromatic hydroxyamine, and the aromatic diamine, each and independently, a derivative that can be polycondensed may be used.

Examples of the polymerizable derivative of a compound containing a carboxy group, such as an aromatic hydroxycarboxylic acid or an aromatic dicarboxylic acid, include a derivative (ester) obtained by converting a carboxy group to an alkoxycarbonyl group or an aryloxycarbonyl group, a derivative (acid halide) obtained by converting a carboxy group to a haloformyl group, and a derivative (acid anhydride) obtained by converting a carboxy group to an acyloxycarbonyl group.

Examples of the polymerizable derivative of a compound containing a hydroxy group, such as an aromatic hydroxycarboxylic acid, an aromatic diol, or an aromatic hydroxyamine, include a derivative (acylated product) obtained by acylating a hydroxy group and converting the acylated group to an acyloxy group.

Examples of the polymerizable derivative of a compound containing an amino group, such as an aromatic hydroxyamine or an aromatic diamine, include a derivative (acylated product) obtained by acylating an amino group and converting the acylated group to an acylamino group.

From the viewpoints of the liquid crystallinity, the dielectric loss tangent of the film, and the adhesiveness of the film to metal foil or metal wire, the liquid crystal polymer has preferably a constitutional repeating unit represented by any of Formulae (1) to (3) (hereinafter, the constitutional repeating unit and the like represented by Formula (1) will also be referred to as the repeating unit (1) and the like), more preferably a constitutional repeating unit represented by Formula (1), and particularly preferably a constitutional repeating unit represented by Formula (1), a constitutional repeating unit represented by Formula (2), and a constitutional repeating unit represented by Formula (3),

—O—Ar¹—CO— Formula (1)

—CO—Ar²—CO— Formula (2)

—X—Ar³—Y— Formula (3)

in Formulae (1) to (3), Ar¹ represents a phenylene group, a naphthylene group, or a biphenylylene group, Ar² and Ar³ each independently represent a phenylene group, a naphthylene group, a biphenylylene group, or a group represented by Formula (4), X and Y each independently represent an oxygen atom or an imino group, and hydrogen atoms in the groups represented by Ar¹ to Ar³ may be each independently substituted with a halogen atom, an alkyl group, or an aryl group,

—Ar⁴—Z—Ar⁵— Formula (4)

in Formula (4), Ar⁴ and Ar⁵ each independently represent a phenylene group or a naphthylene group, and Z represents an oxygen atom, a sulfur atom, a carbonyl group, a sulfonyl group, or an alkylene group.

Examples of the halogen atom of include a fluorine atom, a chlorine atom, a bromine atom, and an iodine atom.

Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group, and an n-decyl group, and the number of carbon atoms thereof is preferably in a range of 1 to 10.

Examples of the aryl group include a phenyl group, an o-tolyl group, an m-tolyl group, a p-tolyl group, a 1-naphthyl group, and a 2-naphthyl group, and the number of carbon atoms is preferably in a range of 6 to 20.

In a case where the hydrogen atom is substituted with any of these groups, the number thereof is preferably 2 or less and more preferably 1 for each group independently represented by Ar¹, Ar², or Ar³.

Examples of the alkylene group include a methylene group, a 1,1-ethanediyl group, a 1-methyl-1,1-ethanediyl group, a 1,1-butanediyl group, and a 2-ethyl-1,1-hexanediyl group, and the number of carbon atoms thereof is preferably in a range of 1 to 10.

The repeating unit (1) is a constitutional repeating unit derived from a predetermined aromatic hydroxycarboxylic acid.

Preferred examples of the repeating unit (1) include a constitutional repeating unit in which Ar¹ represents a p-phenylene group (constitutional repeating unit derived from p-hydroxybenzoic acid), a constitutional repeating unit in which Ar¹ represents a 2,6-naphthylene group (constitutional repeating unit derived from 6-hydroxy-2-naphthoic acid), and a constitutional repeating unit in which Ar¹ represents a 4,4′-biphenylylene group (constitutional repeating unit derived from 4′-hydroxy-4-biphenylcarboxylic acid).

The repeating unit (2) is a constitutional repeating unit derived from a predetermined aromatic dicarboxylic acid.

Preferred examples of the repeating unit (2) include a constitutional repeating unit in which Ar² represents a p-phenylene group (constitutional repeating unit derived from terephthalic acid), a constitutional repeating unit in which Ar² represents an m-phenylene group (constitutional repeating unit derived from isophthalic acid), a constitutional repeating unit in which Ar² represents a 2,6-naphthylene group (constitutional repeating unit derived from 2,6-naphthalenedicarboxylic acid), and a constitutional repeating unit in which Ar² represents a diphenylether-4,4′-diyl group (constitutional repeating unit derived from diphenylether-4,4′-dicarboxylic acid).

The repeating unit (3) is a constitutional repeating unit derived from a predetermined aromatic diol, an aromatic hydroxylamine, or an aromatic diamine.

Preferred examples of the repeating unit (3) include a constitutional repeating unit in which Ar^{a} represents a p-phenylene group (constitutional repeating unit derived from hydroquinone, p-aminophenol, or p-phenylenediamine), a constitutional repeating unit in which Ar^{a} represents an m-phenylene group (constitutional repeating unit derived from isophthalic acid), and a constitutional repeating unit in which Ar^{a} represents a 4,4′-biphenylylene group (constitutional repeating unit derived from 4,4′-dihydroxybiphenyl, 4-amino-4′-hydroxybiphenyl, or 4,4′-diaminobiphenyl).

The content of the repeating unit (1) is preferably 30% by mole or greater, more preferably in a range of 30% by mole to 80% by mole, still more preferably in a range of 30% by mole to 60% by mole, and particularly preferably in a range of 30% by mole to 40% by mole with respect to the total amount of all constitutional repeating units (value obtained by dividing the mass of each constitutional repeating unit constituting the liquid crystal polymer by the formula weight of each repeating unit to acquire the amount (mole) equivalent to the substance amount of each constitutional repeating unit and adding up the acquired values).

The content of the repeating unit (2) is preferably 35% by mole or less, more preferably in a range of 10% by mole to 35% by mole, still more preferably in a range of 20% by mole to 35% by mole, and particularly preferably in a range of 30% by mole to 35% by mole with respect to the total amount of all constitutional repeating units.

The content of the repeating unit (3) is preferably 35% by mole or less, more preferably in a range of 10% by mole to 35% by mole, still more preferably in a range of 20% by mole to 35% by mole, and particularly preferably in a range of 30% by mole to 35% by mole with respect to the total amount of all constitutional repeating units.

The heat resistance, the strength, and the rigidity are likely to be improved as the content of the repeating unit (1) increases, but the solubility in a solvent is likely to be decreased in a case where the content thereof is extremely large.

The ratio of the content of the repeating unit (2) to the content of the repeating unit (3) is expressed as [content of repeating unit (2)]/[content of repeating unit (3)] (mol/mol) and is preferably in a range of 0.9/1 to 1/0.9, more preferably in a range of 0.95/1 to 1/0.95, and still more preferably in a range of 0.98/1 to 1/0.98.

The liquid crystal polymer may have two or more kinds of each of the repeating units (1) to (3) independently. Further, the liquid crystal polymer may have a constitutional repeating unit other than the repeating units (1) to (3), but the content thereof is preferably 10% by mole or less and more preferably 5% by mole or less with respect to the total amount of all the repeating units.

The liquid crystal polymer has preferably a repeating unit in which at least one of X or Y represents an imino group, that is, at least one of a constitutional repeating unit derived from a predetermined aromatic hydroxylamine or a constitutional repeating unit derived from an aromatic diamine as the repeating unit (3) from the viewpoint of excellent solubility in a solvent and more preferably only a repeating unit in which at least one of X or Y represents an imino group as the repeating unit (3).

It is preferable that the liquid crystal polymer is produced by melt-polymerizing raw material monomers corresponding to the constitutional repeating units constituting the liquid crystal polymer. The melt polymerization may be carried out in the presence of a catalyst, and examples of the catalyst include metal compounds such as magnesium acetate, stannous acetate, tetrabutyl titanate, lead acetate, sodium acetate, potassium acetate, and antimony trioxide, and nitrogen-containing heterocyclic compounds such as 4-(dimethylamino)pyridine and 1-methylimidazole. Among these, the nitrogen-containing heterocyclic compounds are preferably used. The melt polymerization may be further carried out by solid phase polymerization as necessary.

The flow start temperature of the liquid crystal polymer is preferably 250° C. or higher, more preferably 250° C. or higher and 350° C. or lower, and still more preferably 260° C. or higher and 330° C. or lower. In a case where the flow start temperature of the liquid crystal polymer is in the above-described range, the solubility, the heat resistance, the strength, and the rigidity are excellent, and the viscosity of the solution is appropriate.

The flow start temperature, also referred to as a flow temperature, is a temperature at which a viscosity of 4,800 Pa·s (48,000 poises) is exhibited in a case where the liquid crystal polymer is melted and extruded from a nozzle having an inner diameter of 1 mm and a length of 10 mm while the temperature is raised at a rate of 4° C./min under a load of 9.8 MPa (100 kg/cm²) using a capillary rheometer and is a guideline for the molecular weight of liquid crystal polyester (“Liquid Crystal Polymers-Synthesis/Molding/Applications-”, written by Naoyuki Koide, CMC Corporation, Jun. 5, 1987, see p. 95).

Further, the weight-average molecular weight of the liquid crystal polymer is preferably 1,000,000 or less, more preferably 3,000 to 300,000, still more preferably in a range of 5,000 to 100,000, and particularly preferably in a range of 5,000 to 30,000. In a case where the weight-average molecular weight of the liquid crystal polymer is in the above-described range, the film after heat treatment is excellent in thermal conductivity, heat resistance, strength, and rigidity in the thickness direction.

From the viewpoint of reducing transmission loss, the dielectric loss tangent of the liquid crystal polymer is preferably 0.01 or less, more preferably 0.005 or less, still more preferably 0.004 or less, and particularly preferably 0.003 or less.

The method of measuring the dielectric loss tangent of the polymer film or the resin in the present disclosure is as follows.

The dielectric loss tangent is measured by the resonance perturbation method at a frequency of 10 GHz. A 10 GHz cavity resonator (CP531, manufactured by EM labs, Inc.) is connected to a network analyzer (“E8363B”, manufactured by Agilent Technology), and a film or resin sample (width: 2.0 mm×length: 80 mm) is inserted into the cavity resonator, and the dielectric loss tangent of the film or the resin is measured based on a change in resonance frequency before and after the insertion in an environment of a temperature of 25° C. and a humidity 60% RH. Further, the copper foil is removed with ferric chloride before the measurement.

The polymer film according to the present disclosure may contain only one or two or more kinds of the resins.

From the viewpoints of the dielectric loss tangent of the film and the adhesiveness of the film to the metal foil or the metal wire, the content of the resin in the polymer film according to the present disclosure is preferably in a range of 20% by mass to 99% by mass, more preferably in a range of 30% by mass to 98% by mass, and particularly preferably in a range of 40% by mass to 95% by mass with respect to the total mass of the film.

Liquid Crystal Polymer Particles

The particle-containing layer contains liquid crystal polymer particles, and the content of the liquid crystal polymer particles in the particle-containing layer is 40% by volume or greater.

From the viewpoints of the dielectric loss tangent of the film and the rupture elongation, it is preferable that the liquid crystal polymer particles have a low solubility in an organic solvent and more preferable that the liquid crystal polymer particles are substantially insoluble in an organic solvent. Specifically, for example, the solubility of the liquid crystal polymer particles in N-methylpyrrolidone at 140° C. is preferably 1% by mass or less, more preferably 0.5% by mass or less, and particularly preferably 0.1% by mass or less.

The preferred embodiments of the liquid crystal polymer in the liquid crystal polymer particles in the present disclosure are the same as the preferred embodiments of the liquid crystal polymer described above.

From the viewpoint of decreasing the dielectric loss tangent of the particle-containing layer, it is preferable that the dielectric loss tangent of the liquid crystal polymer particles is less than that of at least one resin selected from the group consisting of the liquid crystal polymer, the polysulfone resin, the polyethersulfone resin, and the polyphenylene sulfide resin.

The dielectric loss tangent of the liquid crystal polymer particles is preferably 0.01 or less, more preferably 0.005 or less, still more preferably 0.004 or less, and particularly preferably greater than 0 and 0.003 or less.

Further, the dielectric loss tangent of the liquid crystal polymer particles is measured by the above-described method after preparing a green compact sample (width: 2.0 mm×length: 80 mm) by compression molding.

The median diameter (D50) of the liquid crystal polymer particles is not particularly limited and may be appropriately selected as desired, but is preferably in a range of 0.01 μm to 100 μm, more preferably in a range of 0.05 μm to 50 μm, still more preferably in a range of 0.1 μm to 30 μm, and particularly preferably in a range of 1 μm to 20 μm from the viewpoints of the dispersibility and the tensile strength.

The median diameter of the particles in the present disclosure is a diameter in which the total volume of particles on a large-diameter side and the total volume of particles on a small-diameter side is equal to each other in a case where the entirety of the liquid crystal polymer particles are divided into two sides of particles with a particle diameter at which the cumulative volume reaches 50% as a threshold.

In the present disclosure, the median diameter of the particles is measured using MICROTRAC MT3300EXII (manufactured by Nikkiso Co., Ltd.).

From the viewpoint of the rupture elongation of the film, it is preferable that the liquid crystal polymer particles include liquid crystal polymer particles obtained by performing an oxidation treatment on the surface of each particle.

The method of producing the liquid crystal polymer particles obtained by performing an oxidation treatment on the surface of each particle is not particularly limited, but it is preferable that the method includes an oxidation treatment step of oxidizing the surface of each liquid crystal polymer particle.

Oxidation Treatment Step

The oxidation treatment step is preferably a step of oxidizing the surface of the liquid crystal polymer particles using an oxidizing agent and more preferably a step of bringing the liquid crystal polymer particles and the oxidizing agent into contact with each other in an aqueous solution to oxidize the surface of each liquid crystal polymer particle.

The pH of the aqueous solution is not particularly limited as long as the surface of the particle can be oxidized, but is preferably 8 or greater, more preferably 12 or greater, and still more preferably 13 or greater.

The upper limit of the pH of the aqueous solution is not limited and is, for example, 14.

The time for brining the liquid crystal polymer particles and the oxidizing agent into contact with each other in the aqueous solution is preferably in a range of 0.1 hours to 24 hours, more preferably 0.5 hours to 10 hours, and still more preferably in a range of 1.5 hours to 6 hours.

Further, the temperature of the aqueous solution in a case where the liquid crystal polymer particles and the oxidizing agent are brought into contact with each other is preferably in a range of 1° C. to 95° C., more preferably in a range of 25° C. to 80° C., and still more preferably in a range of 45° C. to 65° C.

The method of bringing the liquid crystal polymer particles and the oxidizing agent into contact with each other in the aqueous solution is not limited, and examples thereof include a method of mixing the particles and the oxidizing agent so that the particles and the oxidizing agent come into contact with each other by performing a treatment using a crusher or a grinder such as a rocking mill, a beads mill, a ball mill, a Henschel mixer, a jet mill, a star-burst, or a paint conditioner, a method of bringing the particles and the oxidizing agent into contact with each other while performing a stirring treatment using a mechanical stirrer such as a three-one motor or a magnetic stirrer, and a method of bringing the particles and the oxidizing agent into contact with each other while circulating an oxidizing agent aqueous solution containing the oxidizing agent or the like in a cartridge filled with the liquid crystal polymer particles using a pump.

In the middle of the method of bringing the particles and the oxidizing agent into contact with each other while circulating the solution, the entirety of the liquid crystal polymer particles and the oxidizing agent aqueous solution to be subjected to a modifying step are regarded as the aqueous solution as a whole even in a case where a part of the oxidizing agent aqueous solution is in contact with the liquid crystal polymer particles filling the cartridge and the other part of the oxidizing agent aqueous solution is present in the pump or the like and thus is not in contact with the liquid crystal polymer particles.

It is preferable that the liquid crystal polymer particles and the oxidizing agent are brought into contact with each other in the aqueous solution and the obtained liquid crystal polymer particles are taken out from the aqueous solution.

The method of taking out the liquid crystal polymer particles from the aqueous solution is not particularly limited, and a known method can be used, and examples of the known method include a method of filtering the aqueous solution to separate the liquid crystal polymer particles as residues.

It is also preferable that the liquid crystal polymer particles that have been taken out are washed with water, an organic solvent, or the like.

Oxidizing Agent

In the oxidation treatment step, it is preferable to use an oxidizing agent.

It is preferable that the aqueous solution contains an oxidizing agent.

The oxidizing agent is not limited, and examples thereof include a persulfate such as sodium persulfate, potassium persulfate, or ammonium persulfate, a nitrate such as cerium ammonium nitrate, sodium nitrate, or ammonium nitrate, a peroxide such as hydrogen peroxide or tert-butyl hydroperoxide, a manganese compound such as potassium permanganate or manganese dioxide, a chromium compound such as potassium chromate or potassium dichromate, a hypervalent iodine compound such as potassium periodate or sodium periodate, a quinone compound such as p-benzoquinone, 1,2-naphthoquinone, anthraquinone, or chloranil, an amine oxide compound such as N-methylmorpholine N-oxide, a salt of halogen oxo-acid such as sodium hypochlorite or sodium chlorite, and a double salt (OXONE, manufactured by Dupont) consisting of potassium peroxymonosulfate, potassium hydrogensulfate, and potassium sulfate.

Among these, from the viewpoints of the oxidizability, the dispersibility, and the tensile strength, it is preferable that the oxidizing agent includes a persulfate and more preferable that the oxidizing agent is a persulfate.

Further, from the viewpoint of the oxidizability, the aqueous solution contains, as the oxidizing agent, preferably at least one compound selected from the group consisting of sodium persulfate, potassium persulfate, ammonium persulfate, hydrogen peroxide, potassium permanganate, sodium hypochlorite, cerium ammonium nitrate, potassium chromate, potassium dichromate, and a double salt consisting of potassium peroxymonosulfate, potassium hydrogensulfate, and potassium sulfate, more preferably at least one compound selected from the group consisting of sodium persulfate, potassium persulfate, ammonium persulfate, hydrogen peroxide, sodium hypochlorite, cerium ammonium nitrate, and a double salt consisting of potassium peroxymonosulfate, potassium hydrogensulfate, and potassium sulfate, and particularly preferably at least one compound selected from the group consisting of sodium persulfate, potassium persulfate, and ammonium persulfate.

Further, a catalyst may be used separately from the oxidizing agent in order to assist the action of the oxidizing agent. Examples of the catalyst include a divalent iron compound (FeSO₄ or the like) and a trivalent iron compound.

Further, the oxidizing agent and the catalyst may be respectively a hydrate.

From the viewpoint of the oxidizability, the standard oxidation reduction potential of the oxidizing agent is preferably 0.30 V or greater, more preferably 1.50 V or greater, and still more preferably 1.70 or greater. The upper limit of the standard oxidation reduction potential of the oxidizing agent is not particularly limited, but is, for example, preferably 4.00 V or less and more preferably 2.50 V or less.

The standard oxidation reduction potential is based on the standard hydrogen electrode.

The content of the oxidizing agent in the aqueous solution is preferably in a range of 0.05 parts by mass to 20 parts by mass, more preferably in a range of 0.1 parts by mass to 20 parts by mass, and particularly preferably in a range of 1 part by mass to 20 parts by mass with respect to 100 parts by mass of water in the aqueous solution.

The oxidizing agent may be used alone or in combination of two or more kinds thereof.

In a case where the aqueous solution contains a catalyst, the content of the oxidizing agent is preferably in a range of 0.005 parts by mass to 2 parts by mass, more preferably in a range of 0.01 parts by mass to 2 parts by mass, and still more preferably in a range of 0.1 parts by mass to 2 parts by mass with respect to 100 parts by mass of water in the aqueous solution.

The catalyst may be used alone or in combination of two or more kinds thereof.

Alkaline Compound

It is preferable that the aqueous solution contains an alkaline compound in addition to the above-described components in order to adjust the pH of the aqueous solution.

Examples of the alkaline compound include an alkali metal hydroxide (sodium hydroxide or the like), an inorganic base such as an alkaline earth metal hydroxide, and an organic base. Among these, an alkali metal hydroxide is preferable.

The content of the alkaline compound in the aqueous solution may be appropriately adjusted such that the pH of the aqueous solution can be adjusted to a desired temperature and is for example, preferably in a range of 0.1 parts by mass to 10 parts by mass with respect to 100 parts by mass of water in the aqueous solution.

Further, the method of producing the liquid crystal polymer particles obtained by performing the oxidation treatment on each surface thereof may include other steps.

It is preferable that the method of producing the liquid crystal polymer particles includes a step of preparing the liquid crystal polymer particles used in the oxidation treatment step.

The liquid crystal polymer particles used in the oxidation treatment step may be prepared by a known method or a commercially available product may be used.

Further, the method of producing the liquid crystal polymer particles may include a washing step of washing the liquid crystal polymer particles obtained by the oxidation treatment step and a drying step of drying the liquid crystal polymer particles obtained by the oxidation treatment step or the washing step.

The washing method in the washing step and the drying method in the drying step are not particularly limited, and known methods can be used.

Other Additives

The liquid crystal polymer particles may contain other additives.

Known additives can be used as other additives. Specific examples thereof include a filler, a leveling agent, an antifoaming agent, an antioxidant, an ultraviolet absorbing agent, a flame retardant, and a colorant.

Further, the liquid crystal polymer particles may contain resins other than the above-described components as other additives.

Examples of the resins other than the liquid crystal polymer include thermoplastic resins such as polyolefin, a cycloolefin polymer, polyamide, polyester, polyether ketone, polycarbonate, polyphenylene ether and a modified product thereof, and polyetherimide, elastomers such as a copolymer of glycidyl methacrylate and polyethylene, and thermosetting resins such as a phenol resin, an epoxy resin, a polyimide resin, and a cyanate resin.

The total content of the other additives is preferably 25 parts by mass or less, more preferably 10 parts by mass or less, and still more preferably 5 parts by mass or less with respect to 100 parts by mass of the content of the liquid crystal polymer.

In the polymer film according to the present disclosure, the liquid crystal polymer particles may be used alone or in combination of two or more kinds thereof.

The content of the liquid crystal polymer particles in the particle-containing layer is 40% by volume or greater, and from the viewpoints of the dielectric loss tangent of the film and the rupture elongation, preferably 45% by volume or greater and 80% by volume or less, more preferably 50% by volume or greater and 75% by volume or less, still more preferably 50% by volume or greater and 70% by volume or less, and particularly preferably 55% by volume or greater and 70% by volume or less.

The content of the liquid crystal polymer particles can be measured by immersing the polymer film in an excessive amount of organic solvent, heating the solution to dissolve the film, and filtering the liquid crystal polymer particles that have not been dissolved in the organic solvent.

Other Additives

The polymer film according to the present disclosure may contain other additives.

Known additives can be used as other additives. Specific examples thereof include a leveling agent, an antifoaming agent, an antioxidant, an ultraviolet absorbing agent, a flame retardant, a colorant, and a filler other than the liquid crystal polymer particles.

The total content of the other additives is preferably 25 parts by mass or less, more preferably 10 parts by mass or less, and still more preferably 5 parts by mass or less with respect to 100 parts by mass of the total content of the resin and the liquid crystal polymer particles.

The average thickness of the particle-containing layer is not particularly limited, but is preferably in a range of 5 μm to 200 μm, more preferably in a range of 10 μm to 150 μm, and still more preferably in a range of 20 μm to 120 μm.

The average thickness of each layer in the polymer film according to the present disclosure is measured by the following method.

The thickness of each layer is evaluated by cutting the wiring board with a microtome and observing the cross section with an optical microscope. Three or more sites of the cross-sectional sample are cut out, the thickness is measured at three or more points in each cross section, and the average value thereof is defined as the average thickness.

Dielectric Loss Tangent

From the viewpoint of reducing the transmission loss of the prepared substrate, the dielectric loss tangent of the polymer film according to the present disclosure is 0.01 or less, preferably 0.005 or less, more preferably 0.004 or less, still more preferably 0.0035 or less, and particularly preferably 0.003 or less.

Thermal Expansion Coefficient

From the viewpoint of thermal stability, the thermal expansion coefficient of the polymer film according to the present disclosure is preferably in a range of −20 ppm/K to 100 ppm/K and more preferably in a range of 0 ppm/K to 80 ppm/K.

The thermal expansion coefficient in the present disclosure is measured by the following method.

A tensile load of 1 g is applied to both ends of a film having a width of 5 mm and a length of 20 mm, and the thermal expansion coefficient is calculated from the inclination of the TMA curve between 30° C. and 150° C. using a thermomechanical analyzer (TMA) in a case where the temperature is raised from 25° C. to 200° C. at a rate of 5° C./min, lowered to 30° C. at a rate of 2° C./min, and raised again at a rate of 5° C./min. Further, the copper foil is removed with ferric chloride before the measurement.

Surface Roughness

The surface roughness Rz of at least one surface of the polymer film according to the present disclosure is preferably in a range of 10 nm to 10,000 nm, more preferably in a range of 10 nm to 5,000 nm, still more preferably in a range of 20 nm to 1,000 nm, and even still more preferably in a range of 50 nm to 500 nm.

In the present disclosure, “surface roughness Rz” denotes a total value of the maximum peak height and the maximum valley depth observed on the roughness curve at the reference length in terms of nanometers.

In the present disclosure, the surface roughness Rz of the surface of the film is measured by the following method.

The roughness curve and the average line of the roughness curve in the surface of a target (liquid crystal polymer film) to be measured are created by measuring 465.48 μm in length and 620.64 μm in width using a non-contact surface/layer cross-sectional shape measuring system VertScan (manufactured by Ryoka System Inc.). The part corresponding to the reference length is extracted from the roughness curve. The surface roughness Rz of the target to be measured is measured by acquiring the total value of the maximum peak height (that is, the height from the average line to the vertex) and the maximum valley depth (that is, the height from the average line to bottom of the valley), observed on the extracted roughness curve.

Examples of the method of forming a film having a surface with a surface roughness Rz of 10 nm to 10,000 nm include a method of generating Benard cells during film formation, a method of using a solution containing a filler and a liquid crystal polymer, a method of phase-separating a material mixed with a liquid crystal polymer during film formation, a method of forming a coating layer on a surface of a film during the film forming process to use a difference in shrinkage between the inside and the surface of the film (reticulation), a method of performing a replica treatment using a mold having a surface with unevenness during solution film formation, and a method of roughening a film after film formation by performing a surface treatment such as sputtering.

Elastic Modulus

From the viewpoints of the mechanical strength and suppression of rupture failure during peeling, the elastic modulus of at least one surface of the polymer film according to the present disclosure at 25° C. is preferably 10 MPa or greater.

Further, it is preferable that the surface satisfying the range of the elastic modulus is a surface satisfying the range of the surface free energy, a surface satisfying the range of the surface coverage, or a surface satisfying the range of the surface free energy and the range of the surface coverage.

In the present disclosure, the elastic modulus of the film surface is measured by the following method.

The elastic modulus of the film surface is acquired using a microsurface hardness meter (“FISHER SCOPE H100VP-HCU”, manufactured by FISCHER INSTRUMENTS K. K.). Specifically, the indentation depth is measured at 25° C. and an appropriate test load within a range where the indentation depth is not greater than 1 μm using a diamond quadrangular pyramid indenter (tip facing angle: 136°), and the storage elastic modulus is calculated from a change in load and displacement during deloading.

The polymer film according to the present disclosure may have a monolayer structure or a multilayer structure.

The polymer film according to the present disclosure may be used as a film provided on a base material such as a metal base material.

It is preferable that the polymer film according to the present disclosure contains, for example, a layer A which is a particle-containing layer, and a layer B which is disposed on the layer A and contains a polymer and a curable compound described below. A polymer film with excellent adhesiveness can be obtained by, for example, bonding the film on a side of the layer A and the metal base material to each other.

The content of the polymer contained in the layer A is preferably in a range of 25% by mass to 99% by mass and more preferably in a range of 40% by mass to 60% by mass with respect to the total mass of the layer A.

The average thickness of the layer A is not particularly limited, but is preferably in a range of 5 μm to 200 μm, more preferably in a range of 10 μm to 150 μm, and still more preferably in a range of 20 μm to 120 μm.

The preferred embodiments of the polymer used for the layer B are the same as the preferred embodiments of the polymer described above except for the description above.

The content of the curable compound in the layer B is preferably in a range of 5% by mass to 75% by mass and more preferably in a range of 10% by mass to 50% by mass with respect to the total mass of the layer B.

The average thickness of the layer B is not particularly limited, but is preferably in a range of 1 μm to 50 μm and more preferably in a range of 10 μm to 30 μm.

The layer A and the layer B may each independently contain other additives.

The preferred embodiments of the other additives used in the layer A or the layer B are the same as the preferred embodiments of the other additives described above.

Curable Compound

It is preferable that the layer B contains a curable compound and more preferable that the curable compound contains a curable compound A which is an oligomer or a polymer.

The curable compound in the present disclosure is a compound containing a curable group and may be any of a monomer, an oligomer, or a polymer.

Further, the curable compound A is an oligomer or a polymer and from the viewpoint of the mechanical strength, it is preferable that the curable compound A is a polymer.

In the present disclosure, the oligomer is a polymer having a weight-average molecular weight of 1,000 or greater and less than 2,000, and the polymer is a polymer having a polymerization average molecular weight of 2,000 or greater.

Further, from the viewpoints of the adhesiveness of the film to the metal foil or metal wire and uneven distribution properties, the curable compound A is preferably an oligomer or polymer having a weight-average molecular weight of 1,000 or greater, more preferably a polymer having a weight-average molecular weight of 2,000 or greater, still more preferably a polymer having a weight-average molecular weight of 3,000 or greater and 200000 or less, and particularly preferably a polymer having a weight-average molecular weight of 5,000 or greater and 100,000 or less.

Further, from the viewpoint of suppressing the wire distortion, the weight-average molecular weight of the curable compound A is preferably 100,000 or less, more preferably 50,000 or less, and particularly preferably 10,000 or less.

Further, the polymer having a dielectric loss tangent of 0.01 or less may have a curable group, but is defined as a compound different from the curable compound A. It is preferable that the curable compound A has a dielectric loss tangent greater than 0.01 and is not a liquid crystal polymer.

Further, from the viewpoint of suppressing wire distortion, it is preferable that the content of the curable compound A is greater on at least one surface of the polymer film according to the present disclosure than the content of the curable compound A inside the film.

Further, from the viewpoint of suppressing wire distortion, it is preferable that the layer A contains particles and contains the curable compound inside the particles or on the surface of the particles.

Examples of the particles include microcapsules and microgels containing the curable compound inside or on the surface.

Among these, microcapsules or microgels containing the curable compound inside are preferable.

Further, it is preferable that the particles are organic resin particles.

The number of curable groups in the curable compound may be one or more or 2 or more, but is preferably 2 or more.

Further, the curable compound may contain only one or two or more kinds of curable groups.

The curable group is not particularly limited as long as the curable group can be cured, and examples thereof include an ethylenically unsaturated group, an epoxy group, an oxetanyl group, an isocyanate group, an acid anhydride group, a carbodiimide group, a N-hydroxyester group, a glyoxal group, an imide ester group, a halogenated alkyl group, a thiol group, a hydroxy group, a carboxy group, an amino group, an amide group, an aldehyde group, and a sulfonic acid group.

In a case where the curable compound A is formed by half cure described below, an ethylenically unsaturated group is preferable as the curable group. In this case, it is preferable to use a polyfunctional ethylenically unsaturated compound as the curable compound.

Suitable examples of the curable compound A include a thermosetting resin.

Examples of the thermosetting resin include an epoxy resin, a phenol resin, an unsaturated imide resin, a cyanate resin, an isocyanate resin, a benzoxazine resin, an oxetane resin, an amino resin, an unsaturated polyester resin, an allyl resin, a dicyclopentadiene resin, a silicone resin, a triazine resin, and a melamine resin. Further, the thermosetting resin is not particularly limited thereto, and known thermosetting resins can be used. These thermosetting resins can be used alone or in combination of a plurality of kinds of thereof.

Further, a commercially available adhesive (so-called varnish or a hot melt adhesive) can also be used as the curable compound A.

Further, suitable examples of the curable compound A include a curable compound obtained by half cure of a monomer.

As the monomer, an ethylenically unsaturated compound is preferable and a polyfunctional ethylenic compound is more preferable.

Examples of the ethylenically unsaturated compound include a (meth) acrylate compound, a (meth)acrylamide compound, a (meth)acrylic acid, a styrene compound, a vinyl acetate compound, a vinyl ether compound, and an olefin compound.

Among these, a (meth)acrylate compound is preferable.

From the viewpoint of the adhesiveness of the film to the metal foil or metal wire, the molecular weight of the monomer is preferably 50 or greater and less than 1,000, more preferably 100 or greater and less than 1,000, and particularly preferably 200 or greater and 800 or less.

Further, in a case where the film contains an ethylenically unsaturated compound as the curable compound, it is preferable that the polymer film according to the present disclosure contains a polymerization initiator. As the polymerization initiator, a thermal polymerization initiator or a photopolymerization initiator is preferable.

As the thermal polymerization initiator or the photopolymerization initiator, known polymerization initiators can be used.

Examples of the thermal polymerization initiator include a thermal radical generator. Specific examples thereof include a peroxide initiator such as benzoyl peroxide or azobisisobutyronitrile, and an azo-based initiator.

Examples of the photopolymerization initiator include a photoradical generator. Specific examples thereof include (a) aromatic ketones, (b) onium salt compounds, (c) organic peroxides, (d) thio compounds, (e) hexaarylbiimidazole compounds, (f) ketooxime ester compounds, (g) borate compounds, (h) azinium compounds, (i) active ester compounds, (j) compounds having a carbon halogen bond, and (k) pyridium compounds.

The polymerization initiator may be used alone or in combination of two or more kinds thereof.

The content of the polymerization initiator is preferably in a range of 0.01% by mass to 30% by mass, more preferably in a range of 0.05% by mass to 25% by mass, and still more preferably in a range of 0.1% by mass to 20% by mass with respect to the total mass of the curable compound.

The layer B may contain only one kind of curable compound, for example, only one kind of curable compound A and may contain two or more kinds of curable compounds.

Further, the layer B may contain only one or two or more kinds of curable compounds A.

From the viewpoints of the dielectric loss tangent of the film and suppressing wire distortion, the content of the curable compound in the layer B is preferably in a range of 0.1% by mass to 70% by mass, more preferably in a range of 1% by mass to 60% by mass, still more preferably in a range of 5% by mass to 60% by mass, and particularly preferably in a range of 10% by mass to 55% by mass with respect to the total mass of the layer B.

Further, from the viewpoints of the dielectric loss tangent of the film and suppressing wire distortion, the content of the curable compound A in the layer B is preferably in a range of 0.1% by mass to 70% by mass, more preferably in a range of 1% by mass to 60% by mass, still more preferably in a range of 5% by mass to 60% by mass, and particularly preferably in a range of 10% by mass to 55% by mass with respect to the total mass of the layer B.

Further, from the viewpoint of suppressing wire distortion, the content of the curable compound A in the layer B is preferably in a range of 30% by mass to 100% by mass, more preferably in a range of 50% by mass to 100% by mass, and particularly preferably in a range of 70% by mass to 100% by mass with respect to the total mass of the curable compound.

Curing Inhibitor

From the viewpoint of controlling the cured state and suppressing wire distortion, it is preferable that the layer B contains a curing inhibitor.

Examples of the curing inhibitor include a polymerization inhibitor and a heat stabilizer, and known curing inhibitors can be used.

Examples of the polymerization inhibitor include p-methoxyphenol, quinones (such as hydroquinone, benzoquinone, and methoxybenzoquinone), phenothiazine, catechols, alkylphenols (such as dibutylhydroxytoluene (BHT)), alkyl bisphenols, zinc dimethyldithiocarbamate, copper dimethyldithiocarbamate, copper dibutyldithiocarbamate, copper salicylate, thiodipropionic acid esters, mercaptobenzimidazole, phosphites, 2,2,6,6-tetramethylpiperidine-1-oxyl (TEMPO), 2,2,6,6-tetramethyl-4-hydroxypiperidine-1-oxyl (TEMPOL), and tris(N-nitroso-N-phenylhydroxylamine)aluminum salt (also known as Cupferron Al).

Examples of the heat stabilizer include a phosphorus-based heat stabilizer such as tris(2,4-di-tert-butylphenyl) phosphite, bis[2,4-bis(1,1-di methyl ethyl)-6-methyl phenyl] ethyl ester phosphorous acid, tetrakis(2,4-di-tert-butyl phenyl)[1,1-biphenyl]-4,4′-diylbisphosphonite, or bis(2,4-di-tert-butylphenyl)pentaerythritol diphosphite, and a lactone-based heat stabilizer such as a reaction product of 8-hydroxy-5,7-di-tert-butyl-furan-2-one and o-xylene.

The curing inhibitor may be used alone or in combination of two or more kinds thereof.

The content of the curing inhibitor is not particularly limited, but is preferably in a range of 0.0001% by mass to 2.0% by mass with respect to the total mass of the layer B.

From the viewpoints of the strength, the thermal expansion coefficient, and the adhesiveness of the film to the metal foil or metal wire, the average thickness of the polymer film according to the present disclosure is preferably in a range of 6 μm to 200 μm, more preferably in a range of 12 μm to 100 μm, and particularly preferably in a range of 20 μm to 60 μm.

The average thickness of the polymer film is measured at optional five sites using an adhesive film thickness meter, for example, an electronic micrometer (product name, “KG3001A”, manufactured by Anritsu Corporation), and the average value of the measured values is defined as the average thickness of the polymer film.

Applications

The polymer film according to the present disclosure can be used for various applications. Among the various applications, the polymer film can be used suitably as a film for an electronic component such as a printed wiring board and more suitably for a flexible printed circuit board.

Further, the polymer film according to the present disclosure can be suitably used as a metal adhesive film.

Method of Producing Polymer Film

A method of producing the polymer film according to the present disclosure is a method including a forming step of coating a base material with a polymer solution that contains at least one resin selected from the group consisting of a liquid crystal polymer, a polysulfone resin, a polyethersulfone resin, and a polyphenylene sulfide resin, liquid crystal polymer particles, and an organic solvent and drying the solution to form a particle-containing layer on the base material and a heating step of heating the particle-containing layer at a temperature higher than or equal to the glass transition temperature of the resin, in which the content of the liquid crystal polymer particles in the particle-containing layer after the heating step is 40% by volume or greater.

It is preferable that the polymer film according to the present disclosure is a polymer film produced by the method of producing the polymer film according to the present disclosure.

In the method of producing the polymer film according to the present disclosure, the preferred embodiments of the above-described components among the components to be used, each component contained in the polymer film to be obtained, and the content of each component are the same as the preferred embodiments in the polymer film according to the present disclosure.

Further, in the method of producing the polymer film according to the present disclosure, the amount of each component to be used is the same as the preferable amount corresponding to the preferred embodiment of the content of each component in the polymer film according to the present disclosure.

In the method of producing the polymer film according to the present disclosure, each preferable physical property value of the polymer film to be obtained is the same as the preferred embodiment in the polymer film according to the present disclosure.

Forming Step

The method of producing the polymer film according to the present disclosure includes a forming step of coating a base material with a polymer solution that contains at least one resin selected from the group consisting of a liquid crystal polymer, a polysulfone resin, a polyethersulfone resin, and a polyphenylene sulfide resin, liquid crystal polymer particles, and an organic solvent and drying the solution to form a particle-containing layer on the base material.

The method of forming the particle-containing layer is not particularly limited, and known methods can be referred to, and suitable examples thereof include a casting method and a coating method. Among these, the casting method is particularly preferable. In a case where the film has a multilayer structure, suitable examples of the method include a co-casting method and a multilayer coating method. Among these, the co-casting method is particularly preferable for relatively thin film formation.

In a case where the multilayer structure of the polymer film is produced by the co-casting method or the multilayer coating method, it is preferable that the co-casting method or the multilayer coating method is performed by using a composition for forming the layer A, composition for forming the layer B, or the like obtained by dissolving or dispersing components of each layer such as the liquid crystal polymer in each organic solvent.

Examples of the organic solvent include a halogenated hydrocarbon such as dichloromethane, chloroform, 1,1-dichloroethane, 1,2-dichloroethane, 1,1,2,2-tetrachloroethane, 1-chlorobutane, chlorobenzene, or o-dichlorobenzene, a halogenated phenol such as p-chlorophenol, pentachlorophenol, or pentafluorophenol, an ether such as diethyl ether, tetrahydrofuran, or 1,4-dioxane, a ketone such as acetone or cyclohexanone, an ester such as ethyl acetate or 7-butyrolactone, a carbonate such as ethylene carbonate or propylene carbonate, an amine such as triethylamine, a nitrogen-containing heterocyclic aromatic compound such as pyridine, a nitrile such as acetonitrile or succinonitrile, an amide such as N,N-dimethylformamide, N,N-dimethylacetamide, or N-methylpyrrolidone, a urea compound such as tetramethylurea, a nitro compound such as nitromethane or nitrobenzene, a sulfur compound such as dimethyl sulfoxide or sulfolane, and a phosphorus compound such as hexamethylphosphoramide or tri-n-butyl phosphate. Among these, two or more kinds thereof may be used in combination.

From the viewpoints of low corrosiveness and satisfactory handleability, an organic solvent containing, as a main component, an aprotic compound, particularly an aprotic compound having no halogen atom is preferable as the organic solvent, and the proportion of the aprotic compound in the entire organic solvent is preferably in a range of 50% by mass to 100% by mass, more preferably in a range of 70% by mass to 100% by mass, and particularly preferably in a range of 90% by mass to 100% by mass. Further, from the viewpoint of easily dissolving the liquid crystal polymer, as the aprotic compound, an amide such as N,N-dimethylformamide, N,N-dimethylacetamide, tetramethylurea, or N-methylpyrrolidone, or an ester such as 7-butyrolactone is preferable, N,N-dimethylformamide, N,N-dimethylacetamide, or N-methylpyrrolidone is more preferable, and N-methylpyrrolidone is particularly preferable.

From the viewpoint of easily dissolving the liquid crystal polymer, a solvent containing a compound having a dipole moment of 3 to 5 as a main component is preferable as the organic solvent, and the proportion of the compound having a dipole moment of 3 to 5 in the entire solvent is preferably in a range of 50% by mass to 100% by mass, more preferably in a range of 70% by mass to 100% by mass, and particularly preferably in a range of 90% by mass to 100% by mass.

It is preferable to use a compound having a dipole moment of 3 to 5 as the aprotic compound.

From the viewpoint of ease removal, a solvent containing, as a main component, a compound having a boiling point of 220° C. or lower at 1 atm is preferable as the organic solvent, and the proportion of the compound having a boiling point of 220° C. or lower at 1 atm in the entire solvent is preferably in a range of 50% by mass to 100% by mass, more preferably in a range of 70% by mass to 100% by mass, and particularly preferably in a range of 90% by mass to 100% by mass.

It is preferable to use a compound having a boiling point of 220° C. or lower at 1 atm as the aprotic compound.

In the method of producing the film, a particle-containing layer is formed on a base material. Further, in a case where the metal layer (metal foil) or the like used in the laminate described below is used as the base material, the base material may be used as it is without being peeled.

Examples of the base material include a metal drum, a metal band, a glass plate, a resin film, and metal foil. Among these, a metal drum, a metal band, or a resin film is preferable.

Examples of the resin film include a polyimide (PI) film, and examples of commercially available products thereof include U-PILEX S and U-PILEX R (manufactured by Ube Corporation), KAPTON (manufactured by Du Pont-Toray Co., Ltd.), and IF30, IF70, and LV300 (manufactured by SKC Kolon PI, Inc.).

Further, the base material may have a surface treatment layer formed on the surface so that the base material can be easily peeled off. Hard chrome plating, a fluororesin, or the like can be used for the surface treatment layer.

The average thickness of the resin film support is not particularly limited, but is preferably 25 μm or greater and 75 μm or less and more preferably 50 μm or greater and 75 μm or less.

Further, the method for removing at least a part of the solvent from a cast or applied film-like composition (a casting film or a coating film) is not particularly limited, and a known drying method can be used.

Stretching Step

The method of producing the polymer film according to the present disclosure may include a stretching step of stretching the film, and may also include a stretching step of stretching the film between the forming step and the heating step.

In the method of producing the polymer film according to the present disclosure, stretching can be appropriately combined from the viewpoint of controlling the molecular alignment of the film to be obtained and adjusting the linear expansion coefficient and the mechanical properties. The stretching method is not particularly limited, and a known method can be referred to, and the stretching method may be carried out in a solvent-containing state or in a dry film state. The stretching in the solvent-containing state may be carried out by gripping and stretching the film, by using a self-contractile force of a web due to drying without stretching the film, or by combining these methods. Stretching is particularly effective for the purpose of improving the rupture elongation and the rupture strength in a case where the brittleness of the film is reduced by addition of an inorganic filler or the like.

Heating Step

The method of producing the polymer film according to the present disclosure includes a heating step of heating the particle-containing layer at a temperature higher than or equal to the glass transition temperature of the resin.

It is presumed that crystallization of the resin proceeds in the film and the dielectric loss tangent of the film can be reduced by performing the heating step.

Further, in a case where a layer other than the particle-containing layer is also formed in the forming step, it is preferable that the layer other than the particle-containing layer is also heated together with the particle-containing layer in the heating step.

In the method of producing the polymer film according to the present disclosure, the amount of dissolved oxygen is preferably 500 ppm or less and more preferably 300 ppm or less at the start of heating the film. In a case where the amount of dissolved oxygen is in the above-described range, a film having a lower dielectric loss tangent can be obtained.

Further, the start of heating denotes the time at which application of heat to the film is started.

In the present disclosure, the amount of dissolved oxygen is measured using a dissolved oxygen meter, for example, a portable oxygen analyzer “ORBISPHERE 3650” (manufactured by Hach Ultra Analytics Inc.).

The heating temperature in the heating step is preferably in a range of 100° C. to 400° C. Further, the heating time is preferably in a range of 0.1 minutes to 10 hours. The heating temperature and the heating time can be appropriately changed depending on the kind of polymer, and can be lowered or shortened by another means such as addition of a catalyst.

The heating step may be performed in an inert gas atmosphere or in an oxygen-containing atmosphere. From the viewpoint of production efficiency, the heating step is performed preferably in an atmosphere with an oxygen concentration of 500 ppm or greater and more preferably in an air atmosphere.

Winding Step

The method of producing the polymer film according to the present disclosure includes preferably a winding step of winding the film into a roll shape and more preferably a winding step of winding the film into a roll shape before the heating step and after the forming step.

It is preferable that the step of winding the film into a roll shape is performed in a nitrogen atmosphere. The amount of dissolved oxygen in the film can be further reduced at the start of heating the film by performing the step in a nitrogen atmosphere.

Unwinding Step

It is preferable that the method of producing the polymer film according to the present disclosure includes an unwinding step of unwinding the roll-shaped film after the winding step.

Further, the peeling force in a case of unwinding the film in the unwinding step is preferably 1.0 kN/m or less.

Peeling Step

The method of producing the polymer film according to the present disclosure may include a peeling step of peeling the film off from the base material after the forming step or after the heating step. A film is obtained by peeling the film off from the base material and can be applied to other applications.

Other Steps

The method of producing the polymer film according to the present disclosure may include other steps in addition to the above-described steps.

Other steps may include known steps.

Laminate

A laminate according to the present disclosure may be a laminate obtained by laminating the polymer film according to the present disclosure, and the laminate includes preferably the polymer film according to the present disclosure and a metal layer or metal wire and more preferably the polymer film according to the present disclosure and a copper layer or copper wire disposed on at least one surface of the film.

Further, it is preferable that the surface of the film on which the metal layer or metal wire is disposed is a surface that satisfies the range of the surface free energy, a surface that satisfies the range of the surface coverage, or a surface that satisfies the range of the surface free energy and the range of the surface coverage.

The surface roughness Ra of the surface of the metal layer or metal wire on the side of the film is preferably 1.0 μm or less and more preferably 0.5 μm or less. In a case where the surface roughness Ra is 1.0 μm or less, the surface resistance at the interface between the film and the metal base material decreases.

The surface roughness Ra in the present disclosure is calculated using a surface roughness meter. For example, the surface roughness Ra is calculated in conformity with the method of calculating the arithmetic average surface roughness Ra of JIS B 0601:2013 using a stylus type surface roughness meter “SURFCORDER SE3500” (manufactured by Kosaka Laboratory Ltd.).

Further, in the measurement of the surface roughness Ra, the metal layer or the metal wire in the laminate is removed by etching with an iron chloride solution, the surface roughness Ra of the surface of the film in contact with the metal layer or metal wire, to which the surface roughness of the metal layer or metal wire has been transferred, is measured, and the measured value is defined as the surface roughness Ra of the surface of the metal layer or metal wire on the side of the film.

Further, the laminate according to the present disclosure includes preferably a metal layer or metal wire, the polymer film according to the present disclosure, and a metal layer or metal wire in this order and more preferably a copper layer or copper wire, the polymer film according to the present disclosure, and a copper layer or copper wire in this order.

Further, it is preferable that the laminate according to the present disclosure includes the polymer film according to the present disclosure, a copper layer or copper wire, the polymer film according to the present disclosure, a metal layer or metal wire, and the polymer film according to the present disclosure in this order. The two polymer films according to the present disclosure used for the laminate may be the same as or different from each other.

The metal layer and the metal wire are not particularly limited and may be known metal layers and metal wires, but for example, a silver layer, a silver wire, a copper layer, or a copper wire is preferable, and a copper layer or a copper wire is more preferable.

Further, it is preferable that the metal layer and the metal wire are metal wires.

Further, the metal in the metal layer and the metal wire is preferably silver or copper and more preferably copper.

Since the polymer film according to the present disclosure can be further cured, for example, after the metal layer or the metal wire is bonded to the film, it is preferable that the laminate according to the present disclosure contains a cured product obtained by curing the curable compound A, from the viewpoint of durability.

The method of bonding the polymer film according to the present disclosure and the metal layer or the metal wire to each other is not particularly limited, and a known laminating method can be used.

The peel strength between the film and the copper layer is preferably 0.5 kN/m or greater, more preferably 0.7 kN/m or greater, still more preferably in a range of 0.7 kN/m to 2.0 kN/m, and particularly preferably in a range of 0.9 kN/m to 1.5 kN/m.

In the present disclosure, the peel strength between the film and the metal layer (for example, the copper layer) is measured by the following method.

A peeling test piece with a width of 1.0 cm is prepared from the laminate of the film and the metal layer, the film is fixed to a flat plate with double-sided adhesive tape, and the strength (kN/m) in a case of peeling the film off from the metal layer at a rate of 50 mm/min is measured by the 180° method in conformity with JIS C 5016 (1994).

The metal layer is preferably a silver layer or a copper layer and more preferably a copper layer. As the copper layer, a rolled copper foil formed by a rolling method or an electrolytic copper foil formed by an electrolytic method is preferable, and a rolled copper foil is more preferable from the viewpoint of bending resistance.

The average thickness of the metal layer, preferably a copper layer, is not particularly limited, but is preferably in a range of 2 μm to 20 μm, more preferably in a range of 3 μm to 18 μm, and still more preferably in a range of 5 μm to 12 μm. The copper foil may be copper foil with a carrier formed on a support (carrier) so as to be peelable. As the carrier, a known carrier can be used. The average thickness of the carrier is not particularly limited, but is preferably in a range of 10 μm to 100 μm and more preferably in a range of 18 μm to 50 μm.

From the viewpoint of the adhesiveness between the polymer film and the metal layer or metal wire, the surface roughness Rz of the surface of the metal layer or metal wire on the side of the particle-containing layer is preferably 1.0 μm or less, more preferably in a range of 20 nm to 1,000 nm, and still more preferably in a range of 50 nm to 500 nm.

Further, from the viewpoint of further exhibiting the effects of the present disclosure, it is preferable that the metal layer contains a group that can interact with the film, on the surface of the metal layer on the side in contact with the film. Further, it is preferable that the group capable of interacting with the film is a group corresponding to a functional group of a compound containing a functional group of the film, such as an amino group and an epoxy group, or a hydroxy group and an epoxy group.

Examples of the group capable of interacting with the film include the groups exemplified as the functional group in the compound containing the functional group.

Among these, from the viewpoints of adhesiveness and ease of performing a treatment, a covalently bondable group is preferable, an amino group or a hydroxy group is more preferable, and an amino group is particularly preferable.

It is also preferable that the metal layer in the laminate according to the present disclosure is processed into, for example, a desired circuit pattern by etching to form a flexible printed circuit board. The etching method is not particularly limited, and a known etching method can be used.

Resin Layer

From the viewpoint of the adhesiveness between the polymer film and the metal layer or metal wire, it is preferable that the laminate according to the present disclosure further includes a resin layer between the polymer film and the metal layer or metal wire.

The resin contained in the resin layer is not particularly limited, and known resins can be used.

Examples of the resin include thermoplastic resins such as a liquid crystal polymer, a fluororesin, a polymerized substance of a compound containing a cyclic aliphatic hydrocarbon group and a group having an ethylenically unsaturated bond, polyether ether ketone, polyolefin, polyamide, polyester, polyphenylene sulfide, polyether ketone, polycarbonate, polyethersulfone, polyphenylene ether and a modified product thereof, and polyetherimide, elastomers such as a copolymer of glycidyl methacrylate and polyethylene, and thermosetting resins such as a phenol resin, an epoxy resin, a polyimide resin, and a cyanate resin.

Among these, from the viewpoints of the dielectric loss tangent of the film, the adhesiveness of the film to the metal layer or metal wire, and the heat resistance, the resin layer contains preferably a liquid crystal polymer and more preferably the resin in the particle-containing layer.

Further, from the viewpoint of the adhesiveness of the film to the metal foil or metal wire, it is preferable that the resin layer contains a resin containing a group that can interact with the metal foil or metal wire. Further, it is preferable that the group capable of interacting with the film is a group corresponding to a functional group of a compound containing a functional group of the film, such as an amino group and an epoxy group, or a hydroxy group and an epoxy group.

The covalently bondable group is not particularly limited as long as the group is capable of forming a covalent bond, and examples thereof include an epoxy group, an oxetanyl group, an isocyanate group, an acid anhydride group, a carbodiimide group, a N-hydroxyester group, a glyoxal group, an imide ester group, a halogenated alkyl group, a thiol group, a hydroxy group, a carboxy group, an amino group, an amide group, an aldehyde group, and a sulfonic acid group. Among these, from the viewpoint of the adhesiveness of the film to the metal foil or metal wire, it is preferable that the group is at least one functional group selected from the group consisting of an epoxy group, an oxetanyl group, an isocyanate group, an acid anhydride group, a carbodiimide group, a N-hydroxy ester group, a glyoxal group, an imide ester group, a halogenated alkyl group, and a thiol group.

In a case where the group present on the surface of the metal foil or metal wire to be bonded is a carboxy group, examples of the group that can be covalently bonded to a carboxy group include a hydroxy group and an epoxy group.

In a case where the group present on the surface of the metal foil or metal wire to be bonded is, for example, —NH₂ (primary amino group), examples of the group that can be covalently bonded to —NH₂ include an isocyanate group and an epoxy group.

Among these, from the viewpoints of suppression of rupture failure during peeling and the adhesiveness, an isocyanate group or an epoxy group is preferable, and an epoxy group is particularly preferable as the covalently bondable group.

Examples of the resin containing an epoxy group include jER Series (manufactured by Mitsubishi Chemical Corporation).

The content of the resin containing a group capable of interacting with the metal foil or metal wire is not particularly limited, but is preferably in a range of 0.01% by mass to 10% by mass, more preferably in a range of 0.02% by mass to 2% by mass, and particularly preferably 0.05% by mass to 1% by mass with respect to the total mass of the resin layer, from the viewpoints of suppression of rupture failure during peeling and the adhesiveness of the film to the metal foil or metal wire.

The resin layer may contain only one or two or more kinds of the resins.

The content of the resin in the resin layer is not particularly limited, but is preferably in a range of 50% by mass to 100% by mass, more preferably in a range of 80% by mass to 100% by mass, and particularly preferably in a range of 90% by mass to 100% by mass with respect to the total mass of the resin layer, from the viewpoint of the adhesiveness of the film to the metal foil or metal wire.

Other Additives

The film according to the present disclosure may contain other additives.

Known additives can be used as other additives. Specific examples of other additives include a leveling agent, an antifoaming agent, an antioxidant, an ultraviolet absorbing agent, a flame retardant, and a colorant.

From the viewpoints of suppression of rupture failure during peeling and the adhesiveness of the film to the metal foil or metal wire, the average thickness of the resin layer is preferably 10 μm or less, more preferably 5 μm or less, still more preferably in a range of 0.5 μm to 5 μm, and particularly preferably in a range of 1 μm to 5 μm.

The method of producing a laminate according to the present disclosure includes a laminate forming step of coating a base material with a polymer solution that contains at least one resin selected from the group consisting of a liquid crystal polymer, a polysulfone resin, a polyethersulfone resin, and a polyphenylene sulfide resin, liquid crystal polymer particles, and an organic solvent and drying the solution to form a laminate including a particle-containing layer on the base material; and a heating step of heating the particle-containing layer at a temperature higher than or equal to a glass transition temperature of the resin, in which the content of the liquid crystal polymer particles in the particle-containing layer after the heating step is 40% by volume or greater.

It is preferable that the laminate according to the present disclosure is a laminate produced by the method of producing the laminate according to the present disclosure.

The preferred embodiments of the laminate forming step and the heating step in the method of producing the laminate according to the present disclosure are the same as the preferred embodiments of the forming step and the heating step in the method of producing the polymer film according to the present disclosure, except for the description below.

Further, in the method of producing the laminate according to the present disclosure, the preferred embodiment of the layer structure of the laminate to be obtained and the preferred embodiments of each layer are the same as the preferred embodiment of the layer structure of the laminate according to the present disclosure and the preferred embodiments of each layer.

The base material in the laminate forming step is not particularly limited, but it is preferable that the base material includes a metal layer or metal wire and more preferable that the base material in the laminate forming step includes a metal layer or metal wire on the surface coated with the polymer solution.

Further, in a case where metal wire is used, it is preferable that the base material is a substrate having metal wire or a resin film having metal wire. The substrate and the resin film are not particularly limited, and known substrates and known resin films can be used.

### EXAMPLES

Hereinafter, the present disclosure will be described in more detail with reference to examples. The materials, the used amounts, the ratios, the treatment contents, the treatment procedures, and the like described in the following examples can be appropriately changed without departing from the gist of the present disclosure. Therefore, the scope of the present disclosure is not limited to the following specific examples. Further, “parts” and “%” are on a mass basis unless otherwise specified.

Dielectric Loss Tangent

The dielectric loss tangent was measured by the resonance perturbation method at a frequency of 10 GHz. A 10 GHz cavity resonator (CP531, manufactured by Kanto Electronics Application and Development, Inc.) was connected to a network analyzer (“E8363B”, manufactured by Agilent Technology), and a film or resin sample (width: 2.0 mm×length: 80 mm) was inserted into the cavity resonator, and the dielectric loss tangent of the polymer film or the resin was measured based on a change in resonance frequency before and after the insertion in an environment of a temperature of 25° C. and a humidity 60% RH.

Rupture Elongation

Three test pieces each having a width of 10 mm and a length of 50 mm were prepared by cutting the polymer film in an optional direction and in a direction orthogonal to the direction, and the temperature and the humidity were adjusted in an atmosphere of 23° C. and a relative humidity of 40% for 24 hours. The sample pieces with a width of 10 mm were set such that the chuck distance reached 30 mm using a Tensilon tensile tester, and a tensile test was performed on the sample pieces at a tensile speed of 10 mm/min. The evaluation was measured three times in each direction, and the average value thereof was acquired.

Preparation of Liquid Crystal Polymer Particles 1

Spherical liquid crystal polymer particles were prepared with reference to Example 1 of WO2019/240153A. The median diameter (D50) thereof was 10 μm, the dielectric loss tangent thereof was 0.0021, and the melting point thereof was 325° C.

Preparation of Liquid Crystal Polymer Particles 2

Spherical liquid crystal polymer particles were prepared with reference to Example 2 of WO2019/240153A. The median diameter (D50) thereof was 40 μm, the dielectric loss tangent thereof was 0.0021, and the melting point thereof was 325° C.

Oxidation treatment of liquid crystal polymer particles 1 (preparation of liquid crystal polymer particles 3)

50 parts of the liquid crystal polymer particles 1 were added to NaOH water (NaOH: 40 parts/water: 400 parts), and the mixture was stirred. Sodium persulfate water (sodium persulfate: 9.6 parts/water: 100 parts) was added thereto, and the mixture was heated to 50° C. and further stirred for 3 hours. The mixture was cooled to room temperature, and the LCP particles were filtered, washed with 500 parts of water, and sufficiently dried at 40° C., thereby obtaining surface-modified liquid crystal polymer particles (liquid crystal polymer particles 3). The median diameter (D50) thereof was 10 μm, the dielectric loss tangent thereof was 0.0021, and the melting point thereof was 325° C.

Production of Resin

940.9 g (5.0 mol) of 6-hydroxy-2-naphthoic acid, 377.9 g (2.5 mol) of 4-hydroxyacetaminophen, 415.3 g (2.5 mol) of isophthalic acid, and 867.8 g (8.4 mol) of acetic anhydride were added to a reactor provided with a stirrer, a torque meter, a nitrogen gas introduction pipe, a thermometer, and a reflux condenser, the gas inside the reactor was substituted with nitrogen gas, and the mixture was heated from room temperature (23° C.) to 140° C. for 60 minutes while being stirred in a nitrogen gas stream and was refluxed at 140° C. for 3 hours.

Thereafter, the mixture was heated from 150° C. to 300° C. for 5 hours while by-product acetic acid and unreacted acetic anhydride were distilled off and maintained at 300° C. for 30 minutes, and the contents were taken out from the reactor and cooled to room temperature.

The obtained solid matter was crushed with a crusher, thereby obtaining a powdery liquid crystal polymer (B1). The flow start temperature of this liquid crystal polymer (B1) was 193° C.

The liquid crystal polymer (B1) obtained above was heated from room temperature to 160° C. for 2 hours and 20 minutes in a nitrogen atmosphere, further heated from 160° C. to 180° C. for 3 hours and 20 minutes, maintained at 180° C. for 5 hours to carry out solid-phase polymerization, cooled, and crushed with a crusher, thereby obtaining a powdery liquid crystal polymer (B2). The flow start temperature of this liquid crystal polymer (B2) was 220° C.

The liquid crystal polymer (B2) obtained above was heated from room temperature (23° C.) to 180° C. for 1 hour and 25 minutes in a nitrogen atmosphere, further heated from 180° C. to 255° C. for 6 hours and 40 minutes, maintained at 255° C. for 5 hours to carry out solid-phase polymerization, and cooled, thereby obtaining a powdery liquid crystal polymer (A). The flow start temperature of the liquid crystal polymer (A) was 302° C. Further, the melting point of the liquid crystal polymer (A) was measured using a differential scanning calorimetry device, and the measured value was 311° C.

Preparation of Liquid Crystal Polymer Solution 1

8 parts of the liquid crystal polymer (A) was added to 92 parts of N-methylpyrrolidone, and the mixture was stirred at 140° C. for 4 hours in a nitrogen atmosphere, thereby obtaining a liquid crystal polymer solution 1 (concentration of solid contents: 8% by mass).

Preparation of Coating Solution

Preparation of Coating Solution 1

The spherical liquid crystal polymer particles 1 (0.80 parts) were mixed with the liquid crystal polymer solution 1 (10.0 parts), thereby preparing a coating solution 1.

Preparation of Coating Solution 2

The spherical liquid crystal polymer particles 1 (1.20 parts) were mixed with the liquid crystal polymer solution 1 (10.0 parts), thereby preparing a coating solution 2.

Preparation of Coating Solution 3

The spherical liquid crystal polymer particles 1 (1.87 parts) were mixed with the liquid crystal polymer solution 1 (10.0 parts), thereby preparing a coating solution 3.

Preparation of Coating Solution 4

The spherical liquid crystal polymer particles 3 (1.20 parts) were mixed with the liquid crystal polymer solution 1 (10.0 parts), thereby preparing a coating solution 4.

Preparation of Coating Solution 5

The spherical liquid crystal polymer particles 2 (1.20 parts) were mixed with the liquid crystal polymer solution 1 (10.0 parts), thereby preparing a coating solution 5.

Preparation of Coating Solution 6

The spherical liquid crystal polymer particles 1 (0.34 parts) were mixed with the liquid crystal polymer solution 1 (10.0 parts), thereby preparing a coating solution 6.

Preparation of Undercoat Liquid

An aminophenol type epoxy resin (“jER630”, manufactured by Mitsubishi Chemical Corporation, 0.04 parts) was mixed with the liquid crystal polymer solution 1 (10.0 parts), thereby preparing an undercoat liquid.

### Example 1

A glass plate was coated with the coating solution 1 using an applicator and dried at 50° C. for 3 hours. Thereafter, the cast film was peeled off from the glass plate and subjected to an annealing treatment (heat treatment) at 300° C. for 3 hours in a nitrogen atmosphere, thereby preparing a polymer film containing 50% by volume of the liquid crystal polymer particles 1. The thickness of the polymer film was 25 μm.

### Example 2

A glass plate was coated with the coating solution 2 using an applicator and dried at 50° C. for 3 hours. Thereafter, the cast film was peeled off from the glass plate and subjected to an annealing treatment at 300° C. for 3 hours in a nitrogen atmosphere, thereby preparing a polymer film containing 60% by volume of the liquid crystal polymer particles 1. The thickness of the polymer film was 32 μm.

### Example 3

A glass plate was coated with the coating solution 3 using an applicator and dried at 50° C. for 3 hours. Thereafter, the cast film was peeled off from the glass plate and subjected to an annealing treatment at 300° C. for 3 hours in a nitrogen atmosphere, thereby preparing a polymer film containing 75% by volume of the liquid crystal polymer particles 1. The thickness of the polymer film was 48 μm.

### Example 4

A glass plate was coated with the coating solution 4 using an applicator and dried at 50° C. for 3 hours. Thereafter, the cast film was peeled off from the glass plate and subjected to an annealing treatment at 300° C. for 3 hours in a nitrogen atmosphere, thereby preparing a polymer film containing 60% by volume of the surface-modified liquid crystal polymer particles 3. The thickness of the polymer film was 31 μm.

### Example 5

A glass plate was coated with the coating solution 5 using an applicator and dried at 50° C. for 3 hours. Thereafter, the cast film was peeled off from the glass plate and subjected to an annealing treatment at 300° C. for 3 hours in a nitrogen atmosphere, thereby preparing a polymer film containing 60% by volume of the liquid crystal polymer particles 2. The thickness of the polymer film was 34 μm.

### Comparative Example 1

A glass plate was coated with the liquid crystal polymer solution 1 (concentration of solid contents: 8% by mass) using an applicator and dried at 50° C. for 3 hours. Thereafter, the cast film was peeled off from the glass plate and subjected to an annealing treatment at 300° C. for 3 hours in a nitrogen atmosphere, thereby preparing a polymer film containing no liquid crystal polymer particles. The thickness of the polymer film was 25 μm.

### Comparative Example 2

A glass plate was coated the coating solution 6 using an applicator and dried at 50° C. for 3 hours. Thereafter, the cast film was peeled off from the glass plate and subjected to an annealing treatment at 300° C. for 3 hours in a nitrogen atmosphere, thereby preparing a polymer film containing 30% by volume of the liquid crystal polymer particles 1. The thickness of the polymer film was 25 μm.

Solubility

9.0 g of N-methylpyrrolidone was added to 1.0 g of the polymer film of Comparative Example 1, and the mixture was heated and stirred at 140° C. in a nitrogen atmosphere. It was confirmed that the mixture was completely dissolved after the heating and stirring for 3 hours.

TABLE 1

| | Median diameter | | Content of liquid | | |
|---|---|---|---|---|---|
| | of liquid crystal | Surface treatment | crystal polymer | | Rupture |
| | polymer particles | on liquid crystal | particles | Dielectric loss | elongation |
| | (μm) | polymer particles | (% by volume) | tangent | (%) |
| Example 1 | 10 | Not performed | 50 | 0.0032 | 15 |
| Example 2 | 10 | Not performed | 60 | 0.0029 | 11 |
| Example 3 | 10 | Not performed | 75 | 0.0025 | 5 |
| Example 4 | 10 | Performed | 60 | 0.0029 | 16 |
| Example 5 | 40 | Not performed | 60 | 0.0031 | 6 |
| Comparative | — | — | — | 0.0053 | 30 |
| example 1 | | | | | |
| Comparative | 10 | Not performed | 30 | 0.0046 | 22 |
| example 2 | | | | | |

As listed in Table 1, the polymer films of Examples 1 to 5 each had a lower dielectric loss tangent as compared with the polymer films of Comparative Examples 1 and 2.

### Example 6

A copper foil was coated with the undercoat liquid (product name, “CF-T9DA-SV 18”, average thickness of 18 μm, surface roughness (Rz) of 0.6 μm, manufactured by Fukuda Metal Foil & Powder Co., Ltd.) and heated and dried at 150° C. for 1 hour to form a resin layer having a thickness of 3 μm on the copper foil. The resin layer was coated with the coating solution 4 using an applicator and dried at 50° C. for 3 hours. The resin layer was subjected to an annealing treatment at 300° C. for 3 hours in a nitrogen atmosphere, thereby preparing a laminate having a resin layer and a particle-containing layer containing 60% by volume of liquid crystal polymer particles on the metal copper foil.

The copper foil was peeled off from the laminate by etching, thereby obtaining a polymer film having a resin layer and a particle-containing layer. The polymer film had a thickness of 35 μm, a dielectric loss tangent of 0.0030, and a rupture elongation of 13%.

What is claimed is:

1. A polymer film comprising:
a particle-containing layer that contains at least one resin selected from the group consisting of a liquid crystal polymer, a polysulfone resin, a polyethersulfone resin, and a polyphenylene sulfide resin, and liquid crystal polymer particles,
wherein a content of the liquid crystal polymer particles in the particle-containing layer is 40% by volume or greater.

2. The polymer film according to claim 1,
wherein the resin is a liquid crystal polymer.

3. The polymer film according to claim 1,
wherein a solubility of the resin in N-methylpyrrolidone at 140° C. is 1% by mass or greater.

4. The polymer film according to claim 1,
wherein the resin contains a liquid crystal polymer having a constitutional repeating unit represented by any of Formulae (1) to (3),
—O—Ar¹—CO— Formula (1)
—CO—Ar²—CO— Formula (2)
—X—Ar³—Y— Formula (3)
in Formulae (1) to (3), Ar¹ represents a phenylene group, a naphthylene group, or a biphenylylene group, Ar² and Ar³ each independently represent a phenylene group, a naphthylene group, a biphenylylene group, or a group represented by Formula (4), X and Y each independently represent an oxygen atom or an imino group, and hydrogen atoms in the groups represented by Ar¹ to Ar³ may be each independently substituted with a halogen atom, an alkyl group, or an aryl group,
—Ar⁴—Z—Ar⁵— Formula (4)
in Formula (4), Ar⁴ and Ar⁵ each independently represent a phenylene group or a naphthylene group, and Z represents an oxygen atom, a sulfur atom, a carbonyl group, a sulfonyl group, or an alkylene group.

5. The polymer film according to claim 1,
wherein the liquid crystal polymer particles have a dielectric loss tangent less than a dielectric loss tangent of the resin.

6. The polymer film according to claim 1,
wherein the liquid crystal polymer particles have a median diameter of 0.1 μm to 30 μm.

7. The polymer film according to claim 1,
wherein the liquid crystal polymer particles include liquid crystal polymer particles, each surface of which is subjected to an oxidation treatment.

8. A laminate comprising:
the polymer film according to claim 1; and
a metal layer or metal wire.

9. The laminate according to claim 8, further comprising:
a resin layer between the polymer film and the metal layer or the metal wire.

10. The laminate according to claim 9,
wherein the resin layer contains the resin in the particle-containing layer.

11. The laminate according to claim 9,
wherein an average thickness of the resin layer is 5 m or less.

12. A method of producing a polymer film, comprising:
a forming step of coating a base material with a polymer solution that contains at least one resin selected from the group consisting of a liquid crystal polymer, a polysulfone resin, a polyethersulfone resin, and a polyphenylene sulfide resin, liquid crystal polymer particles, and an organic solvent and drying the solution to form a particle-containing layer on the base material; and
a heating step of heating the particle-containing layer at a temperature higher than or equal to a glass transition temperature of the resin,
wherein a content of the liquid crystal polymer particles in the particle-containing layer after the heating step is 40% by volume or greater.

13. A method of producing a laminate, comprising:
a laminate forming step of coating a base material with a polymer solution that contains at least one resin selected from the group consisting of a liquid crystal polymer, a polysulfone resin, a polyethersulfone resin, and a polyphenylene sulfide resin, liquid crystal polymer particles, and an organic solvent and drying the solution to form a laminate including a particle-containing layer on the base material; and
a heating step of heating the particle-containing layer at a temperature higher than or equal to a glass transition temperature of the resin,
wherein a content of the liquid crystal polymer particles in the particle-containing layer after the heating step is 40% by volume or greater.

14. The method of producing a laminate according to claim 13,
wherein the base material includes a metal layer or metal wire.

15. The method of producing a laminate according to claim 14,
wherein a surface roughness Rz of a surface of the metal layer or the metal wire on a side of the particle-containing layer is 1.0 μm or less.

16. The method of producing a laminate according to claim 13,
wherein the laminate further includes a resin layer between the base material and the particle-containing layer.

17. The method of producing a laminate according to claim 13,
wherein the resin layer contains the resin in the particle-containing layer.
